(19) United States
(12) Patent Application Publication
(10) Pub. No.: US 2008/0000371 A1
(43) Pub. Date: Jan. 3, 2008

(54) Ink fountain key position adjusting method and apparatus for printing press

(75) Inventors: Shigeru Okada, Ibaraki (JP); Iwao Miyagi, Ibaraki (JP); Shunsuke Hara, Ibaraki (JP); Akihiro Inde, Ibaraki (JP); Masahiro Hirano, Ibaraki (JP)

Correspondence Address: BLAKELY SOKOLOFF TAYLOR & ZAFMAN, 1279 OAKMEAD PARKWAY, SUNNYVALE, CA, 94085-4040, US

(73) Assignee: Komori Corporation

(21) Appl. No.: 11/811,788

(22) Filed: Jun. 11, 2007

(30) Foreign Application Priority Data
Jun. 28, 2006 (JP) 177797/2006

(51) Int. Cl. B41F 31/02

(52) U.S. Cl. 101/364; 101/484

(57) ABSTRACT

In an ink fountain key position adjusting method for a printing press, the temperature of a member of an inking device including an ink fountain roller and ink fountain keys is measured. The position of each ink fountain key with respect to the ink fountain roller is corrected in accordance with the measured member temperature. An ink fountain key position adjusting apparatus is also disclosed.

### BACKGROUND OF THE INVENTION

The present invention relates to an ink fountain key position adjusting method and apparatus for a printing press, which adjust the positions of ink fountain keys with respect to an ink fountain roller.

As shown in FIG. 14, each of a plurality of printing units corresponding to the respective colors and included in a printing press has an inking device (inker) 100. The inking device 100 includes an ink fountain 1 storing ink 2, an ink fountain roller 3 that forms part of the ink fountain 1, N ink fountain keys 4 which are juxtaposed in the axial direction of the ink fountain roller 3 and adjust the ink supply amount, an ink ductor roller 5 to transfer the ink from the ink fountain roller 3, and a plate cylinder 8 which receives the ink from the ink ductor roller 5 via ink rollers 6. The plate cylinder 8 has, on its circumferential surface, a printing plate 7 having a printed image.

In the printing press, the opening ratios of the ink fountain keys 4 with respect to the ink fountain roller 3 are controlled to adjust the amount of ink to be supplied from the ink fountain 1 to the ink fountain roller 3. The ink is supplied from the ink fountain roller 3 to the printing plate 7 via the ink ductor roller 5 and ink rollers 6. A printing paper sheet is printed by the ink supplied to the printing plate 7.

The opening ratio of each ink fountain key 4 is set on the basis of the image area ratio of an area of the printing plate 7 corresponding to the ink fountain key 4 and a preset “image area ratio—ink fountain key opening ratio conversion curve”. The opening ratio of each ink fountain key 4 is set in each color printing unit.

More specifically, as disclosed in Japanese Patent Laid-Open No. 2002-79650, the “image area ratio—ink fountain key opening ratio conversion curve” is set for each color. The opening ratio of each ink fountain key based on the image area ratio of a corresponding area of the printing plate is obtained from the “image area ratio—ink fountain key opening ratio conversion curve” of each color. The obtained ink fountain key opening ratio is added to the home position of the ink fountain key concerned to determine the target position. Then, control is executed to adjust the position of the ink fountain key to the determined target position.

In the above-described conventional ink fountain key position adjusting method, however, the gap amount between the ink fountain key and the ink fountain roller may change as the machine thermally expands due to a temperature change. This may cause changes in color tones of the printed products during printing. To prevent this, the operator sometimes takes out and checks sample paper sheets from the printed products during printing. If the color tones have changed, the operator finely adjusts the ink supply amount by, e.g., adjusting the opening ratios of the ink fountain keys. Fine adjustment of the ink supply amount requires a high skill and much labor. Additionally, the ink supply amount is adjusted only after the color tones change, products printed at that time are wasted.

### SUMMARY OF THE INVENTION

It is an object of the present invention to provide an ink fountain key position adjusting method and apparatus for a printing press, which prevent any changes in color tones of printed products during printing even when the machine thermally expands due to a temperature change.

In order to achieve the above object, according to the present invention, there is provided an ink fountain key position adjusting method for a printing press, comprising the steps of measuring a temperature of one of a plurality of members of an inking device including an ink fountain roller and a plurality of ink fountain keys, and correcting a position of each ink fountain key with respect to the ink fountain roller in accordance with the measured member temperature.

There is also provided an ink fountain key position adjusting apparatus for a printing press, comprising temperature measuring means for measuring a temperature of a member of an ink fountain device including an ink fountain roller and ink fountain keys, and correction means for correcting a position of each ink fountain key in accordance with the measured member temperature output from the temperature measuring means.

### BRIEF DESCRIPTION OF THE DRAWINGS

FIG. 1 is a schematic view for explaining a basic example of an ink fountain key position adjusting method for a printing press according to the present invention;

FIG. 2 is a graph showing the relationship between a frame temperature T and an ink fountain key home position correction amount KOA;

FIG. 3 is a block diagram showing the first embodiment of an ink supply amount control device for a printing press used to practice the present invention;

FIG. 4 is a block diagram of an ink fountain key opening ratio control device connected to the ink supply amount control device;

FIG. 5 is a block diagram of an ink fountain roller rotation amount control device connected to the ink supply amount control device;

FIG. 6 is a view showing the contents of memories of a storage unit in the ink supply amount control device;

FIGS. 7A to 7J are flowcharts divisionally illustrating a processing operation according to an ink fountain key target position correction program in the ink supply amount control device;

FIGS. 8A and 8B are flowcharts divisionally illustrating the processing operation of the ink fountain key opening ratio control device;

FIG. 9 is a flowchart illustrating the processing operation of the ink fountain roller rotation amount control device;

FIG. 10 is a block diagram showing the second embodiment of an ink supply amount control device for a printing press used to practice the present invention;

FIGS. 11A and 11B are flowcharts divisionally illustrating a processing operation according to an ink fountain key target position correction program in the ink supply amount control device;

FIG. 12 is a block diagram showing the third embodiment of an ink supply amount control device for a printing press used to practice the present invention;

FIGS. 13A and 13B are flowcharts divisionally illustrating a processing operation according to an ink fountain key target position correction program in the ink supply amount control device; and

FIG. 14 is a view showing the main part of an inking device (inker) in each color printing unit of a web offset printing press.

### DESCRIPTION OF THE PREFERRED EMBODIMENTS

Printing press ink fountain key position adjustment according to the present invention is roughly classified into a home position correction system/method, an opening ratio correction system/method, and a target position correction system/method. The principles of these systems will be described first.

### [Principle 1: Home Position Correction System]

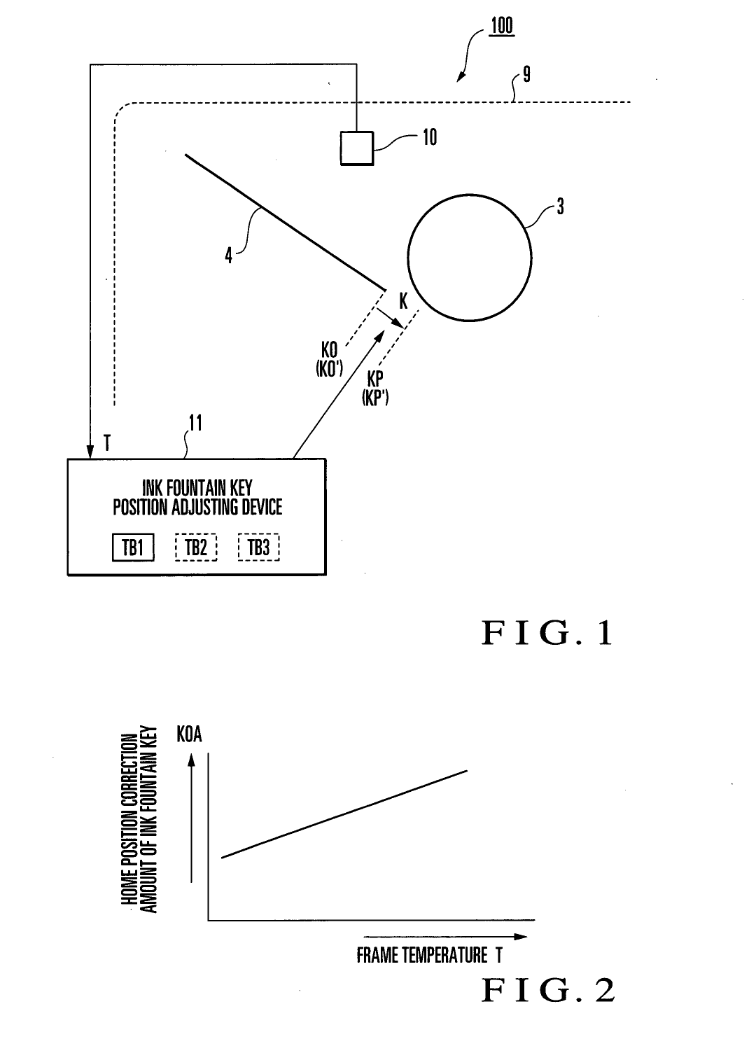

In a system shown in FIG. 1, an ink fountain roller 3, ink fountain key 4, temperature detector 10, and ink fountain key position adjusting device 11 included in an inking device 100 are disposed between a pair of opposing printing press frames 9. The temperature detector 10 provided on one frame 9 near the ink fountain roller 3 or ink fountain key 4 detects a temperature (to be referred to as a frame temperature hereinafter) T of the frame 9 and sends it to the ink fountain key position adjusting device 11.

The temperature detector 10 need only detect the temperature of the frame 9 near the ink fountain roller 3 or ink fountain key 4. Hence, the temperature detector 10 may exist at a frame position near the ink fountain roller 3 or at a frame position near the ink fountain key 4. The temperature detector 10 may be located at an intermediate position between the ink fountain roller 3 and the ink fountain key 4.

### [Adjustment to Target Position]

The ink fountain key position adjusting device 11 obtains, from a predetermined “image area ratio—ink fountain key opening ratio conversion curve”, an opening ratio K of the ink fountain key based on the image area ratio of a corresponding area of a printing plate. The ink fountain key position adjusting device 11 then adds the opening ratio K to a home position KO of the ink fountain key 4 to set a target position KP (KP=KO+K), thereby adjusting the position of the ink fountain key 4 to the set target position KP.

### [Correction of Target Position]

The present inventors examined the influence on the temperature change and found that the frame temperature of the printing press and the ink fountain key home position had a correlation. More specifically, the gap amount between the ink fountain key and the ink fountain roller changes as the machine thermally expands due to a temperature change. This changes the home position of the ink fountain key. Noting this point, the present inventors found the correlation between the ink fountain key home position and the frame temperature of the printing press.

Referring to FIG. 1, first, the correlation between the frame temperature T and the home position KO of the ink fountain key 4 is obtained by repeating experiments. On the basis of the obtained correlation, a conversion table TB1 representing the relationship between the frame temperature T and an ink fountain key home position correction amount KOA is generated and set in the ink fountain key position adjusting device 11, as shown in FIG. 2.

The ink fountain key position adjusting device 11 periodically receives the frame temperature T from the temperature detector 10 and reads out the ink fountain key home position correction amount KOA corresponding to the frame temperature T from the table TB1. The readout ink fountain key home position correction amount KOA is added to the home position KO to obtain a corrected home position KO′ (KO′=KO+KOA). The ink fountain key opening ratio K obtained from the “image area ratio—ink fountain key opening ratio conversion curve” is added to the corrected home position KO′ to obtain a corrected position KP′ (KP′=KO′+K). The position of the ink fountain key 4 is adjusted to the corrected position KP′.

When the target position KP is corrected on the basis of the frame temperature T in the above-described way, the ink fountain key 4 and the ink fountain roller 3 maintain a predetermined gap amount between them so no change takes place in the color tones of printed products during printing. The operator need not finely adjust the ink supply amount. No high skill is necessary, and the labor decreases. Since fine adjustment of the ink supply amount is unnecessary, printed products suffer fewer wasted paper.

The above-described system corrects the home position KO of the ink fountain key 4 upon setting the target position KP, thereby eventually correcting the target position KP of the ink fountain key 4 (home position correction system). Instead, the opening ratio K to be added to the home position KO of the ink fountain key 4 upon setting the target position KP may be corrected to eventually correct the target position KP of the ink fountain key 4 (opening ratio correction system). The target position KP of the ink fountain key 4 itself may be corrected (target position correction system).

### [Principle 2: Opening Ratio Correction System]

To correct the opening ratio K of the ink fountain key 4, a conversion table TB2 (FIG. 1) representing the relationship between the frame temperature T and an ink fountain key opening ratio correction amount KA is generated and set in the ink fountain key position adjusting device 11. In this case, the ink fountain key position adjusting device 11 periodically receives the frame temperature T from the temperature detector 10 and reads out the ink fountain key opening ratio correction amount KA corresponding to the frame temperature T from the table TB2. The readout ink fountain key opening ratio correction amount KA and the ink fountain key opening ratio K obtained from the “image area ratio—ink fountain key opening ratio conversion curve” are added to the home position of the ink fountain key 4 to obtain the corrected position KP′ (KP′=KO+K+KA). The position of the ink fountain key 4 is adjusted to the corrected position KP′.

### [Principle 3: Target Position Correction System]

To correct the target position KP of the ink fountain key 4 itself, a table TB3 representing the relationship between the frame temperature T and an ink fountain key position correction amount KPA is generated and set in the ink fountain key position adjusting device 11. In this case, the ink fountain key position adjusting device 11 periodically receives the frame temperature T from the temperature detector 10 and reads out the ink fountain key position correction amount KPA corresponding to the frame temperature T from the table TB3. The readout ink fountain key position correction amount KPA is added to the target position KP (KP=KO+K) to obtain the corrected position KP′ (KP′=KP+KPA=KO+K+KPA). The position of the ink fountain key 4 is adjusted to the corrected position KP′.

In principles 1 to 3 described above, formulas may be set as the tables TB1, TB2, and TB3. The tables TB2 and TB3 are generated on the basis of the correlation to the frame temperature T by repeating experiments, like the table TB1.

### First Embodiment

### Home Position Correction System

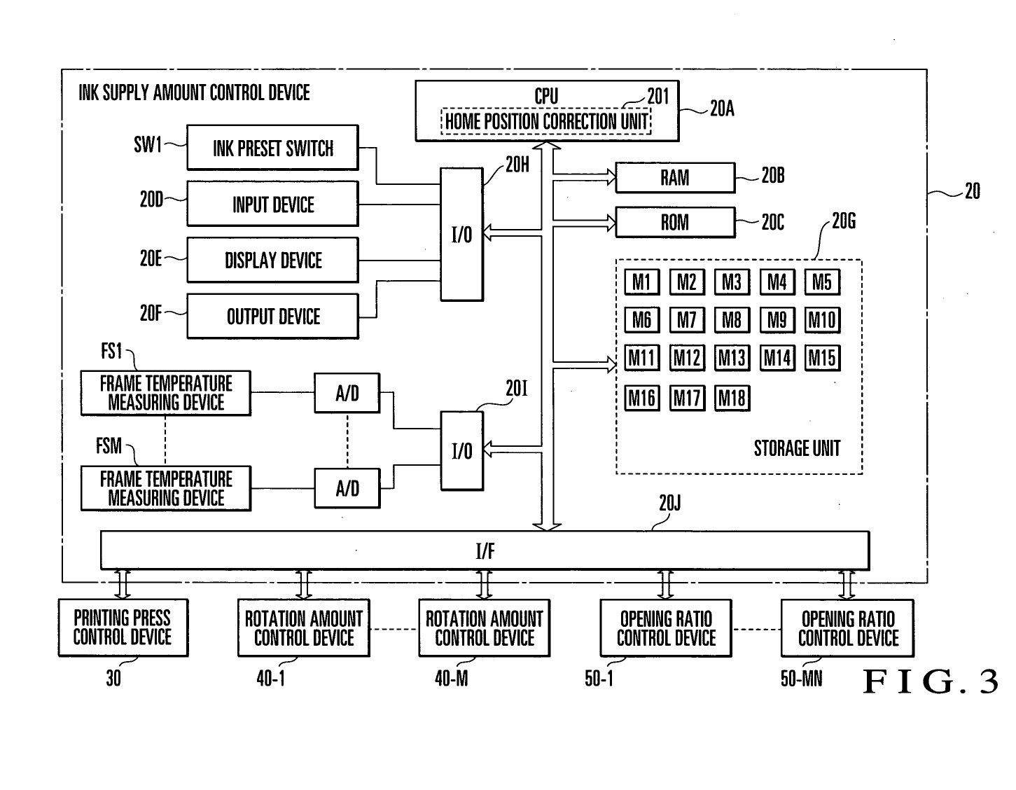

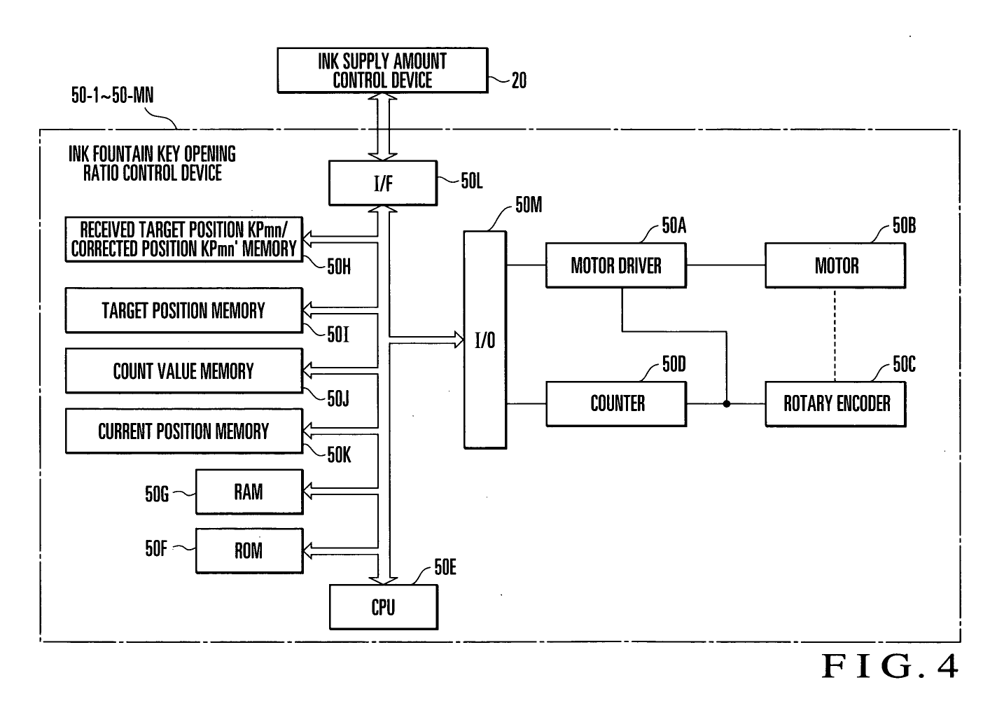

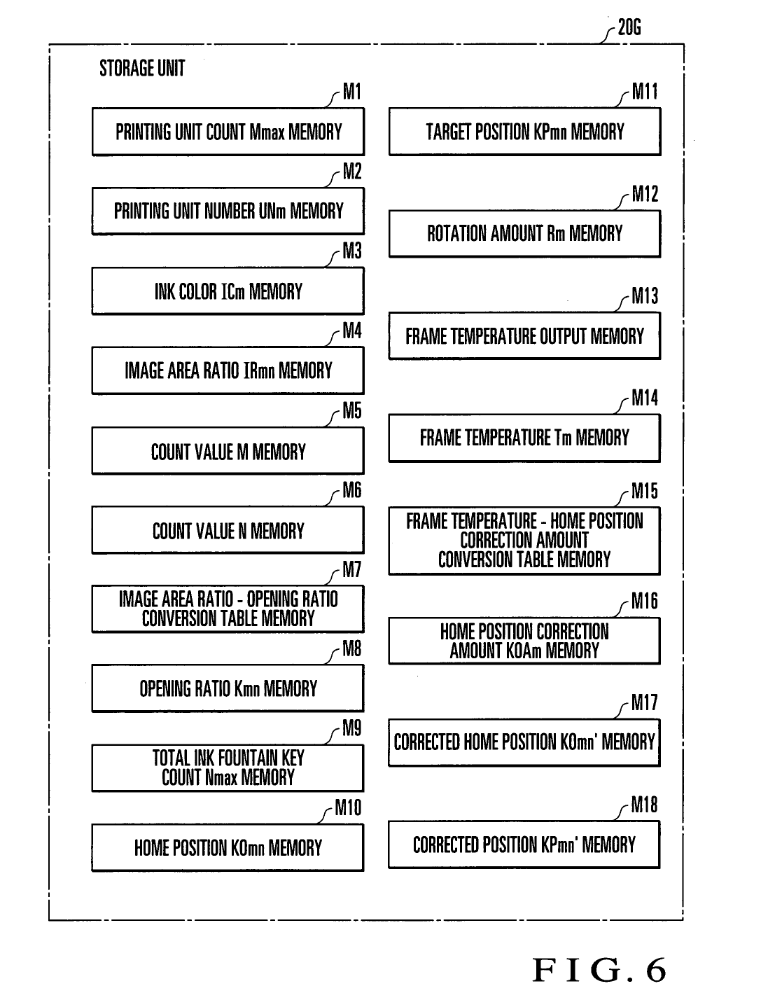

An ink supply amount control device including an ink fountain key position adjusting function according to the first embodiment of the present invention will be described next with reference to FIGS. 3 to 9. As shown in FIG. 3, an ink supply amount control device 20 includes a CPU (Central Processing Unit) 20A functioning as the ink fountain key position adjusting device 11 in FIG. 1, a RAM (Random Access Memory) 20B, a ROM (Read Only Memory) 20C, an ink preset switch SW1, an input device 20D, a display device 20E, an output device 20F including a flexible disk drive and a printer, a storage unit 20G (FIG. 6), frame temperature measuring devices FS1 to FSM corresponding to the temperature detector 10 in FIG. 1, a plurality of A/D converters A/D connected to the frame temperature measuring devices FS1 to FSM, and a plurality of interfaces (I/O I/Fs) 20H to 20J.

The CPU 20A has a home position correction unit 201 that corrects the home position of the ink fountain key 4 in accordance with the outputs from the frame temperature measuring devices FS1 to FSM. The ink supply amount control device 20 connects to a printing press control device 30, ink fountain roller rotation amount control devices (to be referred to as rotation amount control devices hereinafter) 40-1 to 40-M, and ink fountain key opening ratio control devices (to be referred to as opening ratio control devices hereinafter) 50-1 to 50-MN via the interface 20J.

The rotation amount control devices 40-1 to 40-M correspond to the first to Mth printing units of the respective colors. The rotation amount control devices 40-1 to 40-M adjust the feed amounts of the ink fountain rollers 3. The opening ratio control devices 50-1 to 50-MN correspond to all the ink fountain keys 4 of the first to Mth printing units of the respective colors. The opening ratio control devices 50-1 to 50-MN adjust the opening ratios of the ink fountain keys 4 with respect to the ink fountain rollers 3.

The frame temperature measuring devices FS1 to FSM correspond to the first to Mth printing units of the respective colors. The frame temperature measuring devices FS1 to FSM measure the frame temperatures T (T1 to TM) of the printing press near the ink fountain rollers 3 or ink fountain keys 4 of the printing units.

As shown in FIG. 4, each of the opening ratio control devices 50-1 to 50-MN includes an ink fountain key driving motor driver 50A, ink fountain key driving motor 50B, rotary encoder 50C, counter 50D, CPU 50E, ROM 50F, RAM 50G, memories 50H to 50K, and interfaces (I/O I/Fs) 50L and 50M. The memory 50H stores a received target position KPmn or corrected target position KPmn′ of the ink fountain key. The memory 50I stores a target ink fountain key position. The memory 50J stores the count value of the counter 50D. The memory 50K stores the current ink fountain key position.

Each of the opening ratio control devices 50-1 to 50-MN connects to the ink supply amount control device 20 via the interface 50L. The rotary encoder 50C generates a rotation pulse for ever predetermined number of revolutions (angle) of the motor 50B and outputs the pulse to the counter 50D.

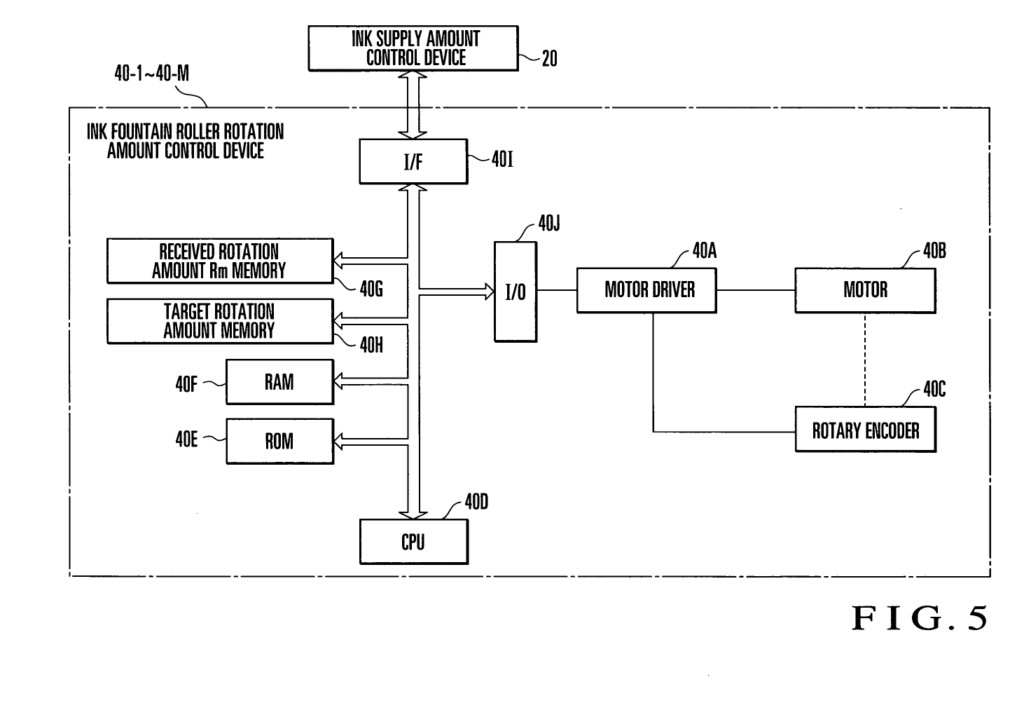

As shown in FIG. 5, each of the rotation amount control devices 40-1 to 40-M includes an ink fountain roller driving motor driver 40A, ink fountain roller driving motor 40B, rotary encoder 40C, CPU 40D ROM 40E, RAM 40F, memories 40G and 40H, and interfaces (I/O I/Fs) 40I and 40J. The memory 40G stores a received rotation amount Rm of the ink fountain roller. The memory 40H stores a target ink fountain roller rotation amount.

Each of the rotation amount control devices 40-1 to 40-M connects to the ink supply amount control device 20 via the interface 40I. The rotary encoder 40C generates a rotation pulse for ever predetermined number of revolutions (angle) of the motor 40B and outputs the pulse to the motor driver 40A.

As shown in FIG. 6, the storage unit 20G includes memories M1 to M18. The memory M1 stores a number Mmax of printing units to be used for printing. The memory M2 stores printing unit numbers UNm to be used for printing. The memory M3 stores ink colors ICm of printing units with the printing unit numbers UNm. The memory M4 stores image area ratios IRmn in areas corresponding to the ink fountain keys. The memory M5 stores a count value M. The memory M6 stores a count value N. The memory M7 stores a conversion table representing the relationship between an image area ratio corresponding to each ink color ICm and the ink fountain key opening ratio K. The memory M8 stores opening ratios Kmn of the ink fountain keys of the printing units with the printing unit numbers UNm. The memory M9 stores a total number Nmax of ink fountain keys of each printing unit. The memory M10 stores home positions KOmn of the ink fountain keys.

The memory M11 stores target positions KPmn of the ink fountain keys of the printing units with the printing unit numbers UNm. The memory M12 stores the rotation amounts Rm of reference ink fountain rollers corresponding to the ink colors ICm. The memory M13 stores the outputs from the frame temperature measuring devices of the printing units with the printing unit numbers UNm. The memory M14 stores frame temperatures Tm of the printing units with the printing unit numbers UNm. The memory M15 stores a conversion table representing the relationship between the frame temperature T of each printing unit and the ink fountain key home position correction amount KOA. The memory M16 stores home position correction amounts KOAm of the ink fountain keys of the printing units with the printing unit numbers UNm. The memory M17 stores corrected home positions KOmn′ of the ink fountain keys of the printing units with the printing unit numbers UNm. The memory M18 stores the corrected positions KPmn′ of the ink fountain keys of the printing units with the printing unit numbers UNm.

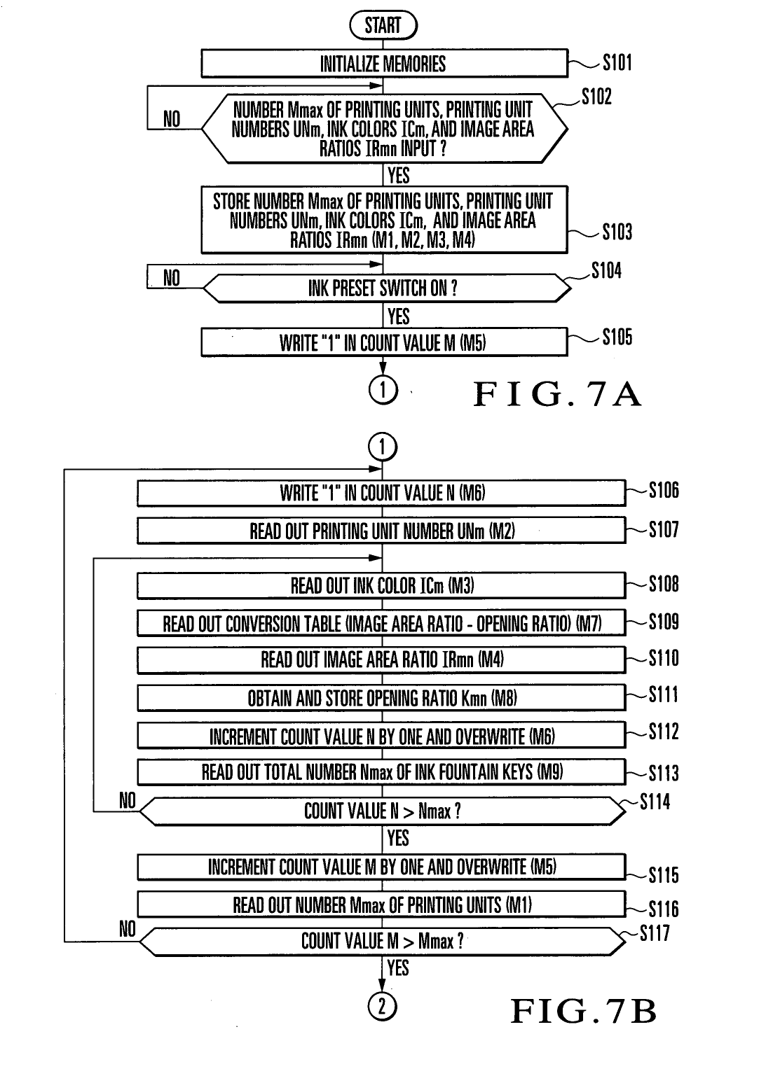

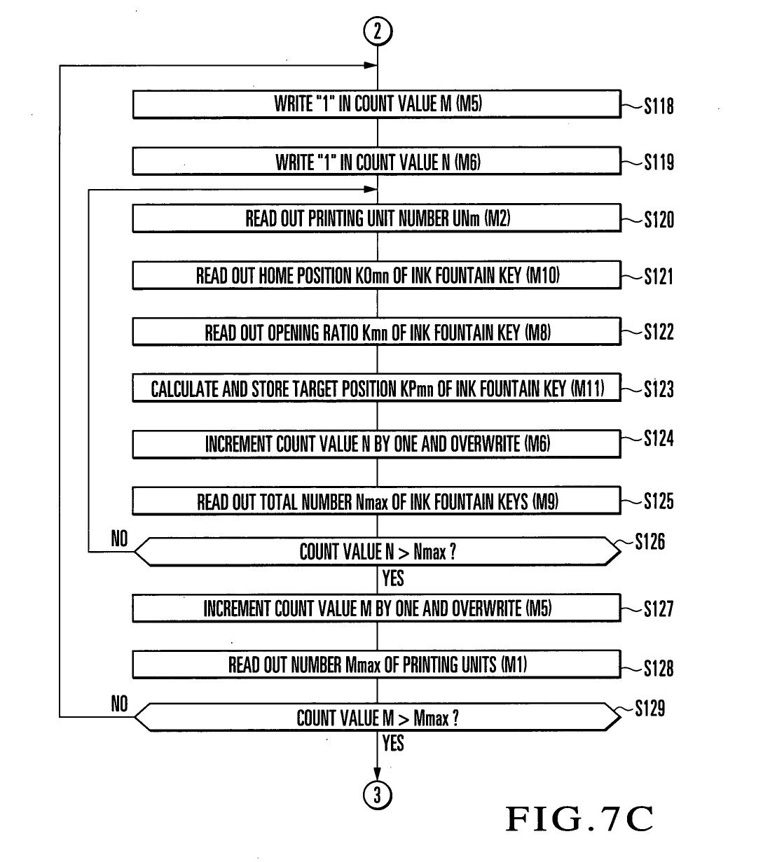

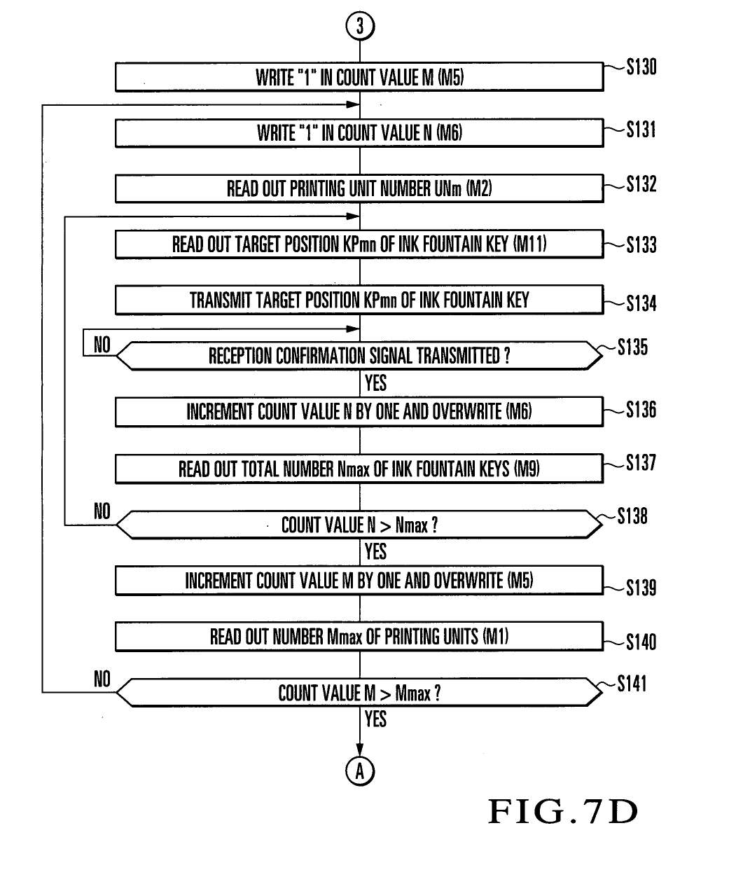

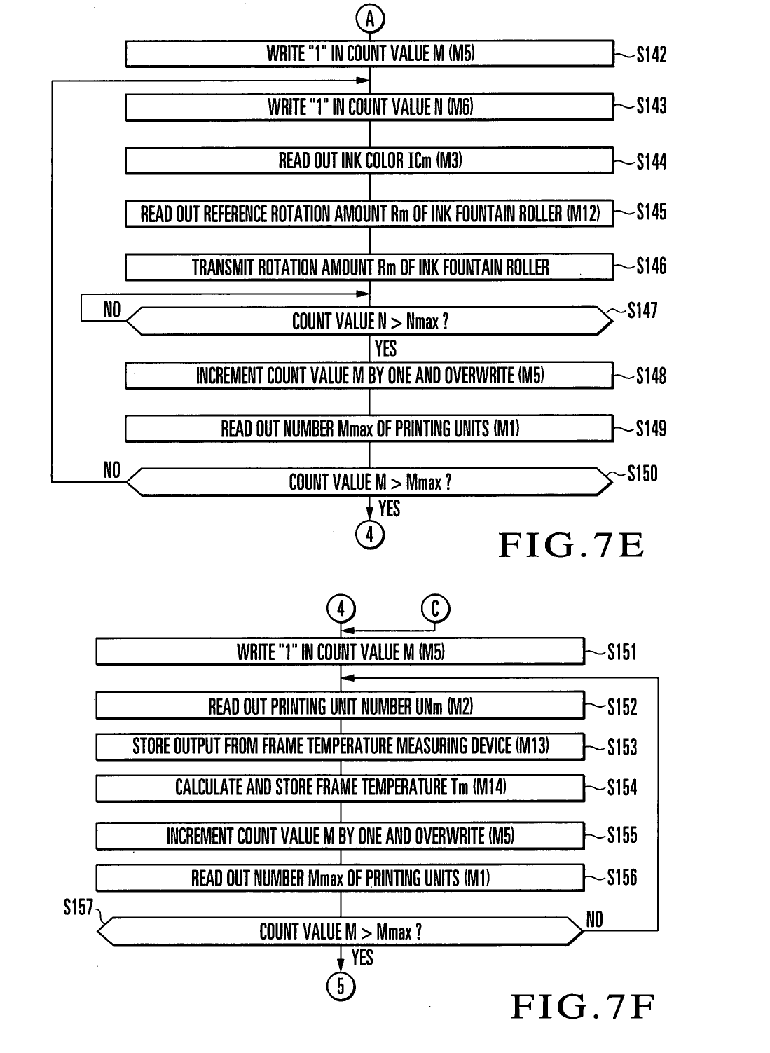

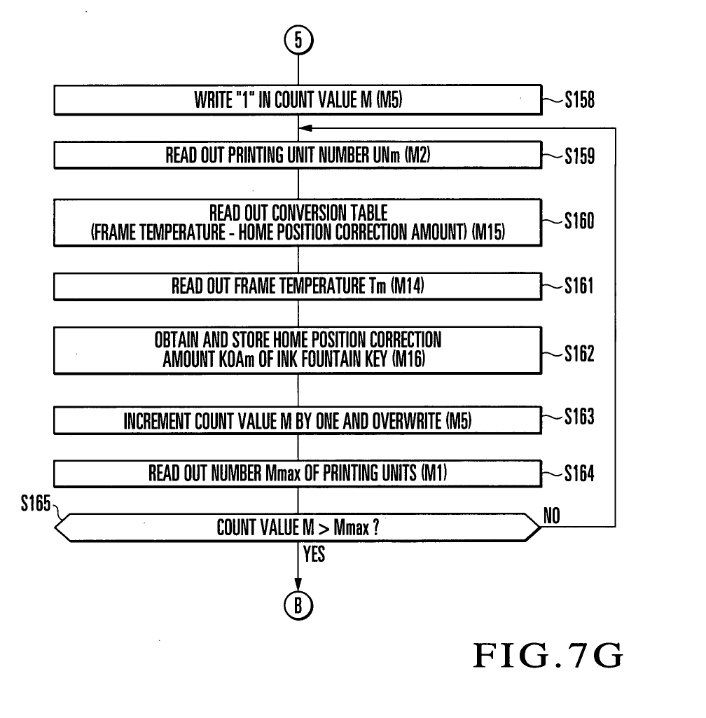

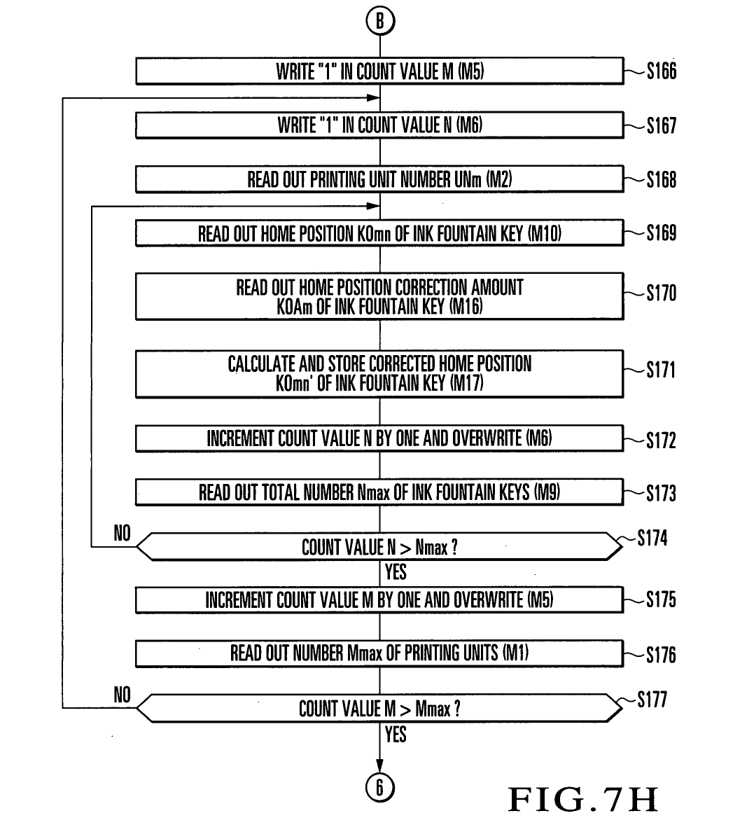

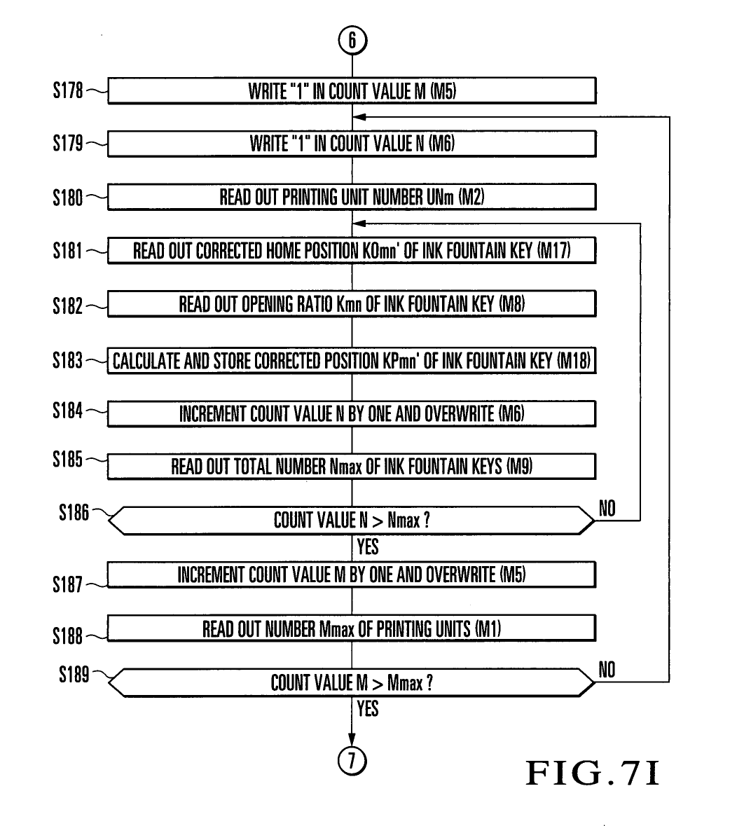

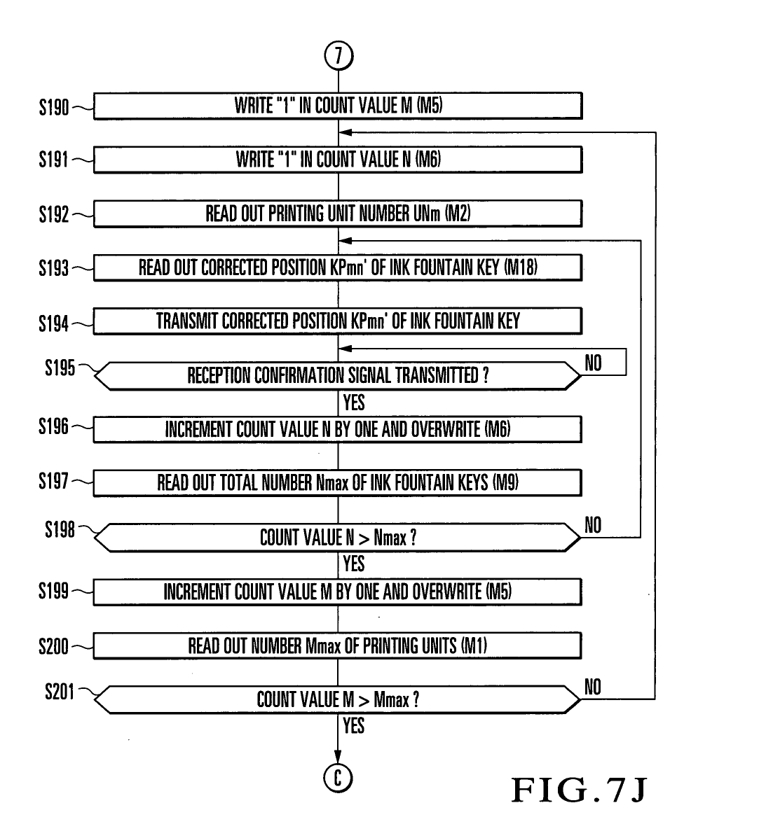

The CPU 20A of the ink supply amount control device 20 obtains various kinds of input information received via the interfaces 20H to 20J and operates in accordance with a program stored in the ROM 20C while accessing the RAM 20B and storage unit 20G. The ROM 20C stores an ink fountain key target position correction program to correct the target position of an ink fountain key as a program unique to this embodiment. An ink fountain key target position correction operation by the CPU 20A will be described below with reference to the flowcharts in FIGS. 7A to 7J.

The CPU 20A initializes the memories M1 to M6, M8, M11, M13, M14, M16, and M17 (FIG. 7A: step S101). The CPU 20A receives the number Mmax of printing units to be used for printing, the printing unit numbers UNm, the ink colors ICm of the printing units with the printing unit numbers UNm, and the image area ratios IRmn in areas corresponding to the ink fountain keys, which are input via the input device 20D (YES in step S102). The CPU 20A stores the number Mmax of printing units to be used for printing in the memory M1, the printing unit numbers UNm in the memory M2, the ink colors ICm of the printing units with the printing unit numbers UNm in the memory M3, and the image area ratios IRmn in areas corresponding to the ink fountain keys in the memory M4 (step S103).

### [Calculation of Ink Fountain Key Opening Ratios]

When the operator turns on the ink preset switch SW1 (YES in step S104), the CPU 20A sets the count value M in the memory M5 to “1” (step S105) and then repeats the processing operation in steps S106 to S117 (FIG. 7B). The opening ratios Kmn of the ink fountain keys of the printing units to be used for printing are obtained by repeating the processing operation in steps S106 to S117.

The processing operation in steps S106 to S117 will be described. The CPU 20A sets the count value N in the memory M6 to “1” (step S106) and reads out, from the memory M2, the printing unit number UNm of the Mth (M=1) printing unit to be used for printing (step S107). The ink color ICm of the printing unit with the Mth (M=1) printing unit number UNm is read out from the memory M3 (step S108). The image area ratio—ink fountain key opening ratio conversion table corresponding to the ink color ICm is read out from the memory M7 (step S109).

The image area ratio IRmn in an area corresponding to the Nth (N=1) ink fountain key of the printing unit with the Mth (M=1) printing unit number UNm is read out from the memory M4 (step S110). The opening ratio Kmn of the Nth (N=1) ink fountain key of the printing unit with the Mth (M=1) printing unit number UNm is obtained by using the image area ratio—ink fountain key opening ratio conversion table read out in step S109 on the basis of the image area ratio IRmn in an area corresponding to the Nth (N=1) ink fountain key of the printing unit with the Mth (M=1) printing unit number UNm and stored in the memory M8 (step S111).

The CPU 20A increments the count value N in the memory M6 by one to set N=2 (step S112) and reads out the total number Nmax of ink fountain keys of each printing unit from the memory M9 (step S113). The process in steps S108 to S114 is repeated until the count value N exceeds the total number Nmax of ink fountain keys. With this process, the opening ratios Kmn of the ink fountain keys of the printing unit with the Mth (M=1) printing unit number UNm are obtained and stored in the memory M8.

If the count value N exceeds Nmax (YES in step S114), the CPU 20A increments the count value M by one to set M=2 (step S115) and reads out, from the memory M1, the number Mmax of printing units to be used for printing (step S116). The process in steps S106 to S117 is repeated until the count value M exceeds the number Mmax of printing units. With this process, the opening ratios Kmn of the ink fountain keys of all printing units to be used for printing are obtained and stored in the memory M8.

### [Calculation of Target Positions of Ink Fountain Keys]

If the count value M exceeds Mmax in step S117, the CPU 20A sets the count value M in the memory M5 to “1” (FIG. 7C: step S118) and repeats the processing operation in steps S119 to S129. The target positions KPmn of the ink fountain keys of the printing units to be used for printing are obtained by repeating the processing operation in steps S119 to S129.

The processing operation in steps S119 to S129 will be described. The CPU 20A sets the count value N in the memory M6 to “1” (step S119) and reads out, from the memory M2, the printing unit number UNm of the Mth (M=1) printing unit to be used for printing (step S120). The home position KOmn of the Nth (N=1) ink fountain key of the printing unit with the Mth (M=1) printing unit number UNm is read out from the memory M10 (step S121). The opening ratio Kmn of the Nth (N=1) ink fountain key of the printing unit with the Mth (M=1) printing unit number UNm is read out from the memory M8 (step S122).

The opening ratio Kmn of the Nth (N=1) ink fountain key of the printing unit with the Mth (M=1) printing unit number UNm is added to the home position KOmn of the Nth (N=1) ink fountain key of the printing unit with the Mth (M=1) printing unit number UNm read out in step S121. The sum is stored, in the memory M11, as the target position KPmn (KPmn=KOmn+Kmn) of the Nth (N=1) ink fountain key of the printing unit with the Mth (M=1) printing unit number UNm (step S123).

The CPU 20A increments the count value N in the memory M6 by one to set N=2 (step S124) and reads out the total number Nmax of ink fountain keys of each printing unit from the memory M9 (step S125). The process in steps S121 to S126 is repeated until the count value N exceeds the total number Nmax of ink fountain keys. With this process, the target positions KPmn of the ink fountain keys of the printing unit with the Mth (M=1) printing unit number UNm are obtained and stored in the memory M11.

If the count value N exceeds Nmax (YES in step S126), the CPU 20A increments the count value M by one to set M=2 (step S127) and reads out, from the memory M1, the number Mmax of printing units to be used for printing (step S128). The process in steps S119 to S129 is repeated until the count value M exceeds the number Mmax of printing units. With this process, the target positions KPmn of the ink fountain keys of all printing units to be used for printing are obtained and stored in the memory M11.

### [Transmission of Target Positions of Ink Fountain Keys]

If the count value M exceeds Mmax in step S129, the CPU 20A sets the count value M in the memory M5 to “1” (FIG. 7D: step S130) and repeats the processing operation in steps S131 to S141. The target positions KPmn of the ink fountain keys of the printing units to be used for printing are transmitted to the opening ratio control devices 50-1 to 50-MN of the printing units by repeating the processing operation in steps S131 to S141.

The processing operation in steps S131 to S141 will be described. The CPU 20A sets the count value N in the memory M6 to “1” (step S131) and reads out, from the memory M2, the printing unit number UNm of the Mth (M=1) printing unit to be used for printing (step S132). The target position KPmn of the Nth (N=1) ink fountain key of the printing unit with the Mth (M=1) printing unit number UNm is read out from the memory M11 (step S133). The readout target position KPmn of the Nth (N=1) ink fountain key of the printing unit with the Mth (M=1) printing unit number UNm is transmitted to one of the opening ratio control devices 50-1 to 50-MN, which corresponds to the Nth (N=1) ink fountain key of the printing unit (step S134).

Upon receiving a reception confirmation signal transmitted from a corresponding one of the opening ratio control devices 50-1 to 50-MN (YES in step S135), the CPU 20A increments the count value N in the memory M6 by one to set N=2 (step S136). The CPU 20A reads out the total number Nmax of ink fountain keys of each printing unit from the memory M9 (step S137). The process in steps S133 to S138 is repeated until the count value N exceeds the total number Nmax of ink fountain keys. With this process, the target positions KPmn of the ink fountain keys of the printing unit with the Mth (M=1) printing unit number UNm are transmitted to the opening ratio control devices 50-1 to 50-MN.

If the count value N exceeds Nmax (YES in step S138), the CPU 20A increments the count value M by one to set M=2 (step S139) and reads out, from the memory M1, the number Mmax of printing units to be used for printing (step S140). The process in steps S131 to S141 is repeated until the count value M exceeds the number Mmax of printing units. With this process, the target positions KPmn of the ink fountain keys of all printing units to be used for printing are transmitted to the opening ratio control devices 50-1 to 50-MN.

### [Transmission of Reference Rotation Amounts of Ink Fountain Rollers]

If the count value M exceeds Mmax in step S141, the CPU 20A sets the count value M in the memory M5 to “1” (FIG. 7E: step S142) and repeats the processing operation in steps S143 to S150. The reference ink fountain roller rotation amounts Rm of the printing units to be used for printing are transmitted to the rotation amount control devices 40-1 to 40-M of the printing units by repeating the processing operation in steps S143 to S150.

The processing operation in steps S143 to S150 will be described. The CPU 20A reads out, from the memory M2, the printing unit number UNm of the Mth (M=1) printing unit to be used for printing (step S143). The ink color ICm of the printing unit with the Mth (M=1) printing unit number UNm is read out from the memory M3 (step S144). The reference rotation amount Rm of the ink fountain roller corresponding to the ink color ICm is read out from the memory M12 (step S145). The readout reference rotation amount Rm of the ink fountain roller corresponding to the ink color ICm is transmitted to a corresponding one of the rotation amount control devices 40-1 to 40-M of the printing unit with the Mth (M=1) printing unit number UNm (step S146).

Upon receiving a reception confirmation signal transmitted from a corresponding one of the rotation amount control devices 40-1 to 40-M (YES in step S147), the CPU 20A increments the count value M in the memory M5 by one to set M=2 (step S148). The CPU 20A reads out the number Mmax of printing units to be used for printing from the memory M1 (step S149). The process in steps S143 to S150 is repeated until the count value M exceeds the number Mmax of printing units. With this process, the reference rotation amounts Rm of the ink fountain rollers of the all printing units used for printing are transmitted to the rotation amount control devices 40-1 to 40-M.

### [Calculation of Frame Temperatures]

If the count value M exceeds Mmax in step S150, the CPU 20A sets the count value M in the memory M5 to “1” (FIG. 7F: step S151) and repeats the processing operation in steps S152 to S157. The frame temperatures Tm of the printing units to be used for printing are calculated by repeating the processing operation in steps S152 to S157.

The processing operation in steps S152 to S157 will be described. The CPU 20A reads out, from the memory M2, the printing unit number UNm of the Mth (M=1) printing unit to be used for printing (step S152). The CPU 20A reads an output from a frame temperature measuring device FS of the printing unit with the Mth (M=1) printing unit number UNm (step S153). The CPU 20A calculates the frame temperature Tm of the printing unit with the Mth (M=1) printing unit number UNm on the basis of the output from the frame temperature measuring device FS of the printing unit (step S154). The calculated frame temperature Tm is stored in the memory M14.

The CPU 20A increments the count value M in the memory M5 by one to set M=2 (step S155) and reads out, from the memory M1, the number Mmax of printing units to be used for printing (step S156). The process in steps S152 to S157 is repeated until the count value M exceeds the number Mmax of printing units. With this process, the frame temperatures Tm of all printing units to be used for printing are obtained and stored in the memory M14.

### [Calculation of Home Position Correction Amounts of Ink Fountain Keys]

If the count value M exceeds Mmax in step S157, the CPU 20A sets the count value M in the memory M5 to “1” (FIG. 7G: step S158) and repeats the processing operation in steps S159 to S165. The home position correction amounts KOAm of the ink fountain keys of the printing units to be used for printing are calculated by repeating the processing operation in steps S159 to S165.

The processing operation in steps S159 to S165 will be described. In step S159, the CPU 20A reads out, from the memory M2, the printing unit number UNm of the Mth (M=1) printing unit to be used for printing (step S159). The frame temperature—ink fountain key home position correction amount conversion table of the printing unit with the Mth (M=1) printing unit number UNm is read out from the memory M15 (step S160). The frame temperature Tm of the printing unit with the Mth (M=1) printing unit number UNm is read out from the memory M14 (step S161).

The home position correction amount KOAm of the ink fountain key of the printing unit with the Mth (M=1) printing unit number UNm is obtained by using the frame temperature—ink fountain key home position correction amount conversion table of the printing unit read out in step S160 on the basis of the frame temperature Tm of the printing unit with the Mth (M=1) printing unit number and stored in the memory M16 (step S162).

The CPU 20A increments the count value M in the memory M5 by one to set M=2 (step S163) and reads out, from the memory M1, the number Mmax of printing units to be used for printing (step S164). The process in steps S159 to S165 is repeated until the count value M exceeds the number Mmax of printing units. With this process, the home position correction amounts KOAm of the ink fountain keys of all printing units to be used for printing are obtained and stored in the memory M16.

### [Correction of Home Positions of Ink Fountain Keys]

If the count value M exceeds Mmax in step S165, the CPU 20A sets the count value M in the memory M5 to “1” (FIG. 7H: step S166) and repeats the processing operation in steps S167 to S177. The corrected home positions KOmn′ of the ink fountain keys of the printing units to be used for printing are obtained by repeating the processing operation in steps S167 to S177.

The processing operation in steps S167 to S177 will be described. The CPU 20A sets the count value N in the memory M6 to “1” (step S167) and reads out, from the memory M2, the printing unit number UNm of the Mth (M=1) printing unit to be used for printing (step S168). The home position KOmn of the Nth (N=1) ink fountain key of the printing unit with the Mth (M=1) printing unit number UNm is read out from the memory M10 (step S169). The home position correction amount KOAm of the ink fountain key of the printing unit with the Mth (M=1) printing unit number UNm is read out from the memory M16 (step S170).

The home position correction amount KOAm of the ink fountain key of the printing unit with the Mth (M=1) printing unit number UNm is added to the home position KOmn of the Nth (N=1) ink fountain key of the printing unit with the Mth (M=1) printing unit number UNm read out in step S169. The sum is stored, in the memory M17, as the corrected home position KOmn′ (KOmn′=KOmn+KOAm) of the Nth (N=1) ink fountain key of the printing unit with the Mth (M=1) printing unit number UNm (step S171).

The CPU 20A increments the count value N in the memory M6 by one to set N=2 (step S172) and reads out the total number Nmax of ink fountain keys of each printing unit from the memory M9 (step S173). The process in steps S167 to S174 is repeated until the count value N exceeds the total number Nmax of ink fountain keys. With this process, the corrected home positions KOmn′ of the ink fountain keys of the printing unit with the Mth (M=1) printing unit number UNm are obtained and stored in the memory M17.

If the count value N exceeds Nmax (YES in step S174), the CPU 20A increments the count value M by one to set M=2 (step S175) and reads out, from the memory M1, the number Mmax of printing units to be used for printing (step S176). The process in steps S167 to S177 is repeated until the count value M exceeds the number Mmax of printing units. With this process, the corrected home positions KOmn′ of the ink fountain keys of all printing units to be used for printing are obtained and stored in the memory M17. The home position correction unit 201 of the CPU 20A executes the above-described process in step S158 to S177.

### [Correction of Target Positions of Ink Fountain Keys]

If the count value M exceeds Mmax in step S177, the CPU 20A sets the count value M in the memory M5 to “1” (FIG. 7I: step S178) and repeats the processing operation in steps S179 to S189. The corrected positions KPmn′ of the ink fountain keys of the printing units to be used for printing are obtained by repeating the processing operation in steps S179 to S189.

The processing operation in steps S179 to S189 will be described. The CPU 20A sets the count value N in the memory M6 to “1” (step S179) and reads out, from the memory M2, the printing unit number UNm of the Mth (M=1) printing unit to be used for printing (step S180). The corrected home position KOmn′ of the Nth (N=1) ink fountain key of the printing unit with the Mth (M=1) printing unit number UNm is read out from the memory M17 (step S181). The opening ratio Kmn of the Nth (N=1) ink fountain key of the printing unit with the Mth (M=1) printing unit number UNm is read out from the memory M8 (step S182).

The opening ratio Kmn of the Nth (N=1) ink fountain key of the printing unit with the Mth (M=1) printing unit number UNm is added to the corrected home position KOmn′ of the Nth (N=1) ink fountain key of the printing unit with the Mth (M=1) printing unit number UNm read out in step S181. The sum is stored, in the memory M18, as the corrected position KPmn′ (KPmn′=KOmn′+Kmn) of the Nth (N=1) ink fountain key of the printing unit with the Mth (M=1) printing unit number UNm (step S183).

The CPU 20A increments the count value N in the memory M6 by one to set N=2 (step S184) and reads out the total number Nmax of ink fountain keys of each printing unit from the memory M9 (step S185). The process in steps S181 to S186 is repeated until the count value N exceeds the total number Nmax of ink fountain keys. With this process, the corrected positions KPmn′ of the ink fountain keys of the printing unit with the Mth (M=1) printing unit number UNm are obtained and stored in the memory M18.

If the count value N exceeds Nmax (YES in step S186), the CPU 20A increments the count value M by one to set M=2 (step S187) and reads out, from the memory M1, the number Mmax of printing units to be used for printing (step S188). The process in steps S179 to S189 is repeated until the count value M exceeds the number Mmax of printing units. With this process, the corrected positions KPmn′ of the ink fountain keys of all printing units to be used for printing are obtained and stored in the memory M18.

### [Transmission of Corrected Positions of Ink Fountain Keys]

If the count value M exceeds Mmax in step S189, the CPU 20A sets the count value M in the memory M5 to “1” (FIG. 7J: step S190) and repeats the processing operation in steps S191 to S201. The corrected positions KPmn′ of the ink fountain keys of the printing units to be used for printing are transmitted to the opening ratio control devices 50-1 to 50-MN of the printing units by repeating the processing operation in steps S191 to S201.

The processing operation in steps S191 to S201 will be described. The CPU 20A sets the count value N in the memory M6 to “1” (step S191) and reads out, from the memory M2, the printing unit number UNm of the Mth (M=1) printing unit to be used for printing (step S192). The corrected position KPmn′ of the Nth (N=1) ink fountain key of the printing unit with the Mth (M=1) printing unit number UNm is read out from the memory M18 (step S193). The readout corrected position KPmn′ of the Nth (N=1) ink fountain key of the printing unit with the Mth (M=1) printing unit number UNm is transmitted to one of the opening ratio control devices 50-1 to 50-MN, which corresponds to the Nth (N=1) ink fountain key of the printing unit (step S194).

Upon receiving a reception confirmation signal transmitted from a corresponding one of the opening ratio control devices 50-1 to 50-MN (YES in step S195), the CPU 20A increments the count value N in the memory M6 by one to set N=2 (step S196). The CPU 20A reads out the total number Nmax of ink fountain keys of each printing unit from the memory M9 (step S197). The process in steps S193 to S198 is repeated until the count value N exceeds the total number Nmax of ink fountain keys. With this process, the corrected positions KPmn′ of the ink fountain keys of the printing unit with the Mth (M=1) printing unit number UNm are transmitted to the opening ratio control devices 50-1 to 50-MN.

If the count value N exceeds Nmax (YES in step S198), the CPU 20A increments the count value M by one to set M=2 (step S199) and reads out, from the memory M1, the number Mmax of printing units to be used for printing (step S200). The process in steps S191 to S201 is repeated until the count value M exceeds the number Mmax of printing units. With this process, the corrected positions KPmn′ of the ink fountain keys of all printing units to be used for printing are transmitted to the opening ratio control devices 50-1 to 50-MN.

If the count value M exceeds Mmax in step S201, the CPU 20A returns to step S151 in FIG. 7F to set the count value M in the memory M5 to “1” and repeat the process in steps S152 to S201. With this process, the above-described calculation of frame temperatures, calculation of ink fountain key home position correction amounts, correction of ink fountain key home positions, correction of ink fountain key target positions, and transmission of corrected ink fountain key positions are repeated.

### [Ink Fountain Key Opening Ratio Control Device]

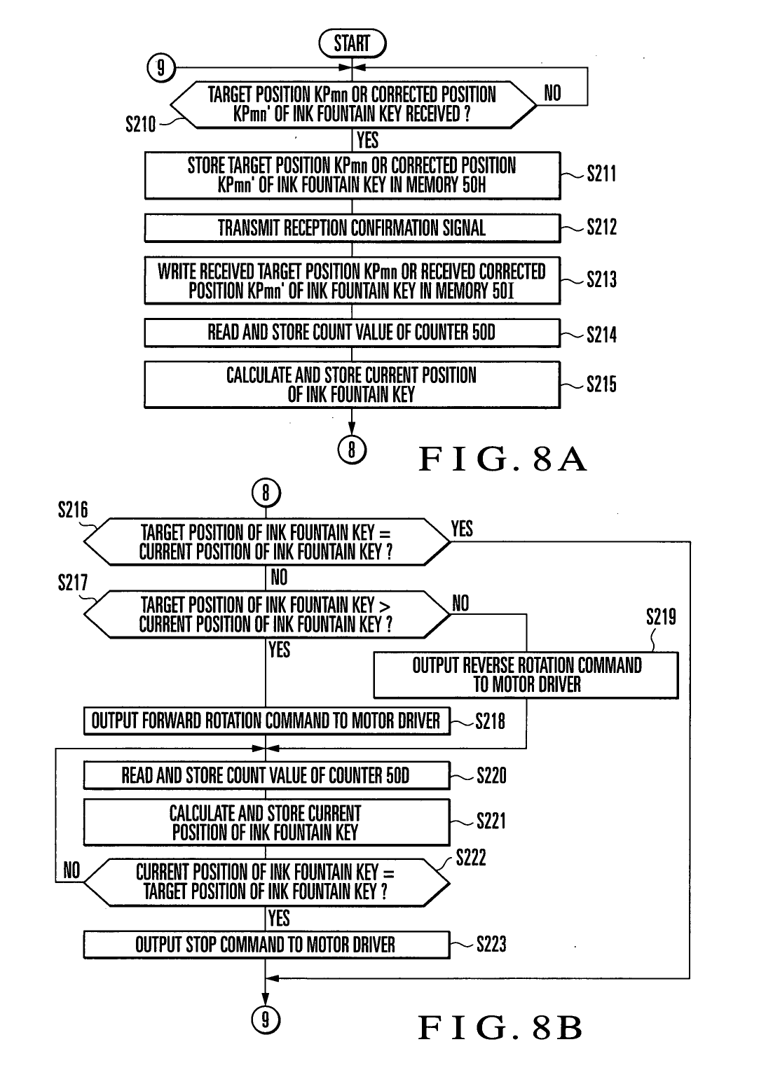

Upon receiving the target position KPmn or corrected position KPmn′ of an ink fountain key from the ink supply amount control device 20 (FIG. 8A: YES in step S210), the CPU 50E (FIG. 4) of each of the opening ratio control devices 50-1 to 50-MN stores, in the memory 50H, the received target position KPmn or corrected position KPmn′ of the ink fountain key (step S211). The CPU 50E transmits a reception confirmation signal to the ink supply amount control device 20 (step S212) and writes the received target position KPmn or corrected position KPmn′ in the memory 50I as the target position of the ink fountain key (step S213).

The CPU 50E reads the count value of the counter 50D (step S214) and obtains the current position of the ink fountain key from the read count value of the counter 50D (step S215). If the current position of the ink fountain key matches the target position (FIG. 8B: YES in step S216), the process returns to step S210 to prepare for reception of the target position KPmn or corrected position KPmn′ of the next ink fountain key from the ink supply amount control device 20.

If the current position of the ink fountain key does not match the target position (NO in step S216), the ink fountain key driving motor 50B is driven until the current position of the ink fountain key matches the target position (steps S217 to S223). Then, the process returns to step S210 to prepare for reception of the target position KPmn or corrected position KPmn′ of the next ink fountain key from the ink supply amount control device 20.

### [Ink Fountain Key Rotation Amount Control Device]

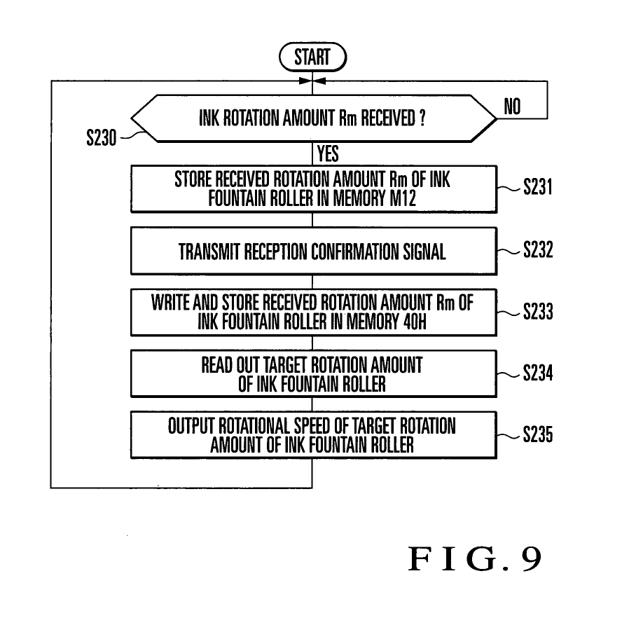

Upon receiving the reference rotation amount Rm of an ink fountain roller from the ink supply amount control device 20 (FIG. 9: YES in step S230), the CPU 40D (FIG. 5) of each of the rotation amount control devices 40-1 to 40-M stores, in the memory 40G, the received reference rotation amount Rm of the ink fountain roller (step S231). The CPU 40D transmits a reception confirmation signal to the ink supply amount control device 20 (step S232) and writes the received reference rotation amount Rm of the ink fountain roller in the memory 40H as the target rotation amount (step S233). The CPU 40D reads out the target rotation amount from the memory 40H (step S324), sends it to the ink fountain roller driving motor driver 40A, and adjusts the rotation amount of the ink fountain roller driving motor 40B to the target rotation amount (reference rotation amount Rm) (step S235).

### Second Embodiment

### Opening Ratio Correction System

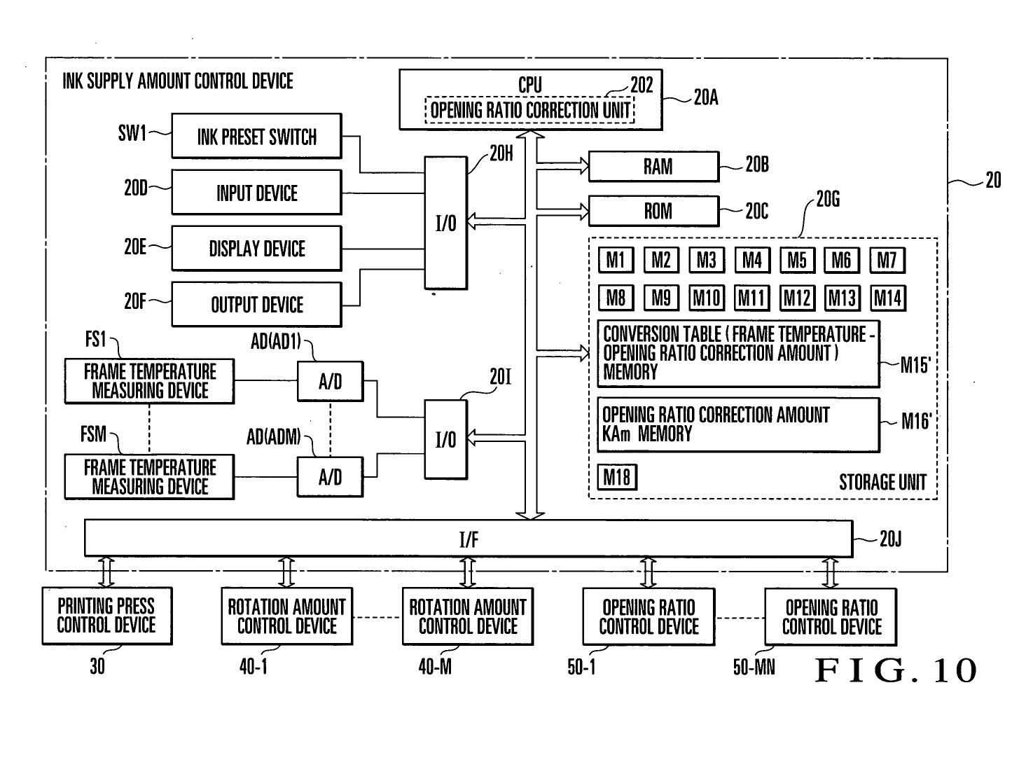

An ink supply amount control device for a printing press according to the second embodiment of the present invention will be described with reference to FIG. 10. The same reference numerals as in FIG. 3 denote the same or similar constituent elements in FIG. 10, and a description thereof will not be repeated. Rotation amount control devices 40-1 to 40-M and opening ratio control devices 50-1 to 50-MN connected to an ink supply amount control device 20 shown in FIG. 10 are also the same as in FIG. 3. A description of the detailed arrangements of these devices shown in FIGS. 4 and 5 and the flowcharts shown in FIGS. 8A, 8B, and 9 will not be repeated.

In the second embodiment, a storage unit 20G incorporates a memory M15′ to store the frame temperature—ink fountain key opening ratio correction amount conversion table of each printing unit, and a memory M16′ to store an opening ratio correction amount KAm of an ink fountain key of a printing unit with a printing unit number UNm in place of the memories M15 and M16 of the first embodiment. A frame temperature—ink fountain key opening ratio correction amount conversion table representing the relationship between a frame temperature T of each printing unit and the opening ratio correction amount KAm of an ink fountain key is set in the memory M15′. A CPU 20A has an opening ratio correction unit 202 that corrects the opening ratios of ink fountain keys 4 in accordance with the outputs from frame temperature measuring devices FS1 to FSM.

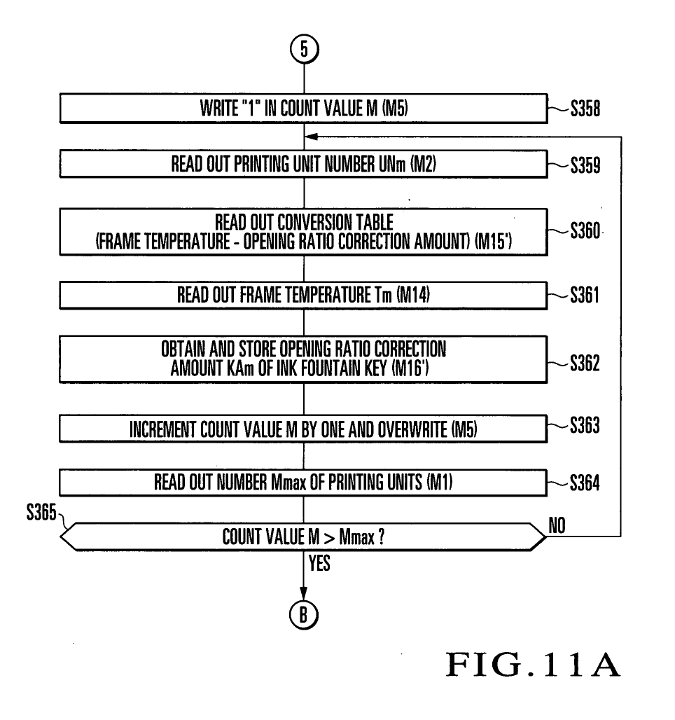

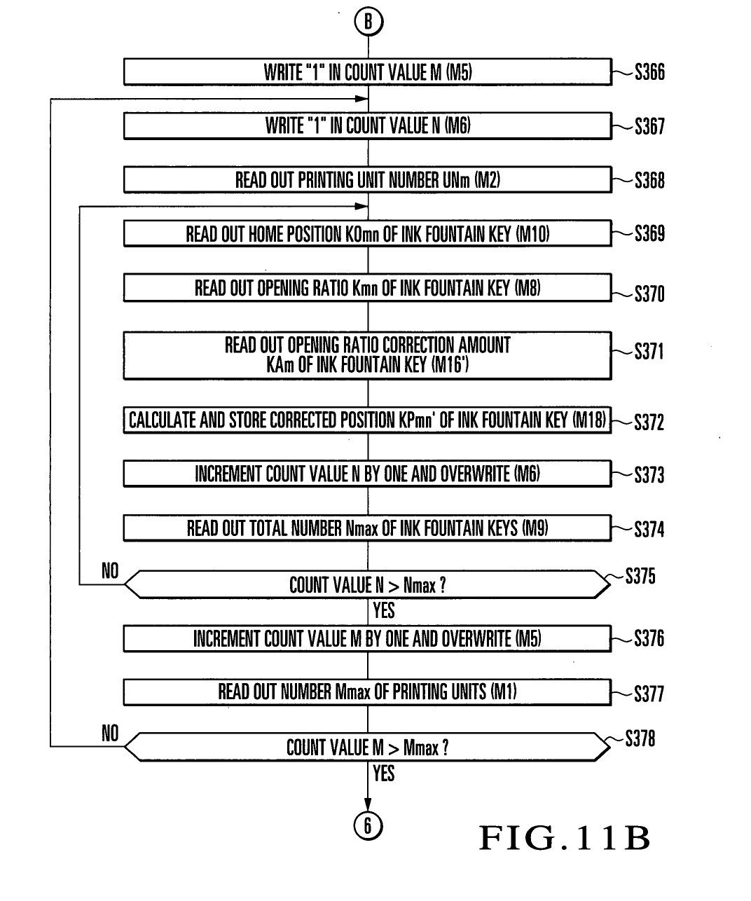

FIGS. 11A and 11B illustrate a processing operation executed by the CPU 20A of the ink supply amount control device 20 according to the second embodiment. In these flowcharts, the processing operation up to step S358 in FIG. 11A is the same as in steps S101 (FIG. 7A) to S157 (FIG. 7F) described in the first embodiment, and a description thereof will not be repeated. The processing operation from step S378 in FIG. 11B is the same as in steps S190 to S201 (FIG. 7J) described in the first embodiment, and a description thereof will not be repeated.

### [Calculation of Opening Ratio Correction Amounts of Ink Fountain Keys]

If a count value M exceeds Mmax in step S157 (FIG. 7F), the CPU 20A sets the count value M in a memory M5 to “1” (FIG. 11A: step S358) and repeats the processing operation in steps S359 to S365. The opening ratio correction amounts KAm of the ink fountain keys of the printing units to be used for printing are calculated by repeating the processing operation in steps S359 to S365.

The processing operation in steps S359 to S365 will be described. The CPU 20A reads out, from a memory M2, the printing unit number UNm of the Mth (M=1) printing unit to be used for printing (step S359). The frame temperature—ink fountain key opening ratio correction amount conversion table of the printing unit with the Mth (M=1) printing unit number UNm is read out from the memory M15′ (step S360). A frame temperature Tm of the printing unit with the Mth (M=1) printing unit number UNm is read out from a memory M14 (step S361).

The opening ratio correction amount KAm of the ink fountain key of the printing unit with the Mth (M=1) printing unit number UNm is obtained by using the frame temperature—ink fountain key opening ratio correction amount conversion table of the printing unit read out in step S360 on the basis of the frame temperature Tm of the printing unit with the Mth (M=1) printing unit number UNm and stored in the memory M16′ (step S362).

The CPU 20A increments the count value M in the memory M5 by one to set M=2 (step S363) and reads out, from a memory M1, a number Mmax of printing units to be used for printing (step S364). The process in steps S359 to S365 is repeated until the count value M exceeds the number Mmax of printing units. With this process, the opening ratio correction amounts KAm of the ink fountain keys of all printing units to be used for printing are obtained and stored in the memory M16′.

### [Correction of Target Positions of Ink Fountain Keys]

If the count value M exceeds Mmax in step S365, the CPU 20A sets the count value M in the memory M5 to “1” (FIG. 11B: step S366) and repeats the processing operation in steps S367 to S378. Corrected positions KPmn′ of the ink fountain keys of the printing units to be used for printing are obtained by repeating the processing operation in steps S367 to S378.

The processing operation in steps S367 to S378 will be described. The CPU 20A sets a count value N in a memory M6 to “1” (step S367) and reads out, from the memory M2, the printing unit number UNm of the Mth (M=1) printing unit to be used for printing (step S368). A home position KOmn of the Nth (N=1) ink fountain key of the printing unit with the Mth (M=1) printing unit number UNm is read out from a memory M10 (step S369). An opening ratio Kmn of the Nth (N=1) ink fountain key of the printing unit with the Mth (M=1) printing unit number UNm is read out from a memory M8 (step S370). The opening ratio correction amount KAm of the ink fountain key of the printing unit with the Mth (M=1) printing unit number UNm is read out from the memory M16′ (step S371).

The CPU 20A adds the home position KOmn of the Nth (N=1) ink fountain key of the printing unit with the Mth (M=1) printing unit number UNm read out in step S369, the opening ratio Kmn of the Nth (N=1) ink fountain key of the printing unit with the Mth (M=1) printing unit number UNm read out in step S370, and the opening ratio correction amount KAm of the ink fountain key of the printing unit with the Mth (M=1) printing unit number UNm read out in step S371. The sum is stored, in a memory M18, as the corrected position KPmn′ (KPmn′=KOmn+Kmn+KAm) of the Nth (N=1) ink fountain key of the printing unit with the Mth (M=1) printing unit number UNm (step S372).

The CPU 20A increments the count value N in the memory M6 by one to set N=2 (step S373) and reads out a total number Nmax of ink fountain keys of each printing unit from a memory M9 (step S374). The process in steps S369 to S375 is repeated until the count value N exceeds the total number Nmax of ink fountain keys. With this process, the corrected positions KPmn′ of the ink fountain keys of the printing unit with the Mth (M=1) printing unit number UNm are obtained and stored in the memory M18.

If the count value N exceeds Nmax (YES in step S375), the CPU 20A increments the count value M by one to set M=2 (step S376) and reads out, from the memory M1, the number Mmax of printing units to be used for printing (step S377). The process in steps S367 to S378 is repeated until the count value M exceeds the number Mmax of printing units. With this process, the corrected positions KPmn′ of the ink fountain keys of all printing units to be used for printing are obtained and stored in the memory M18. The opening ratio correction unit 202 of the CPU 20A executes the above-described process in steps S358 to S377.

### [Transmission of Corrected Positions of Ink Fountain Keys]

If the count value M exceeds Mmax in step S378, the CPU 20A sets the count value M in the memory M5 to “1” (FIG. 7J: step S190) and repeats the processing operation in steps S191 to S201. The corrected positions KPmn′ of the ink fountain keys of the printing units to be used for printing are transmitted to the opening ratio control devices 50-1 to 50-MN of the printing units by repeating the processing operation.

### Third Embodiment

### Opening Ratio Correction System

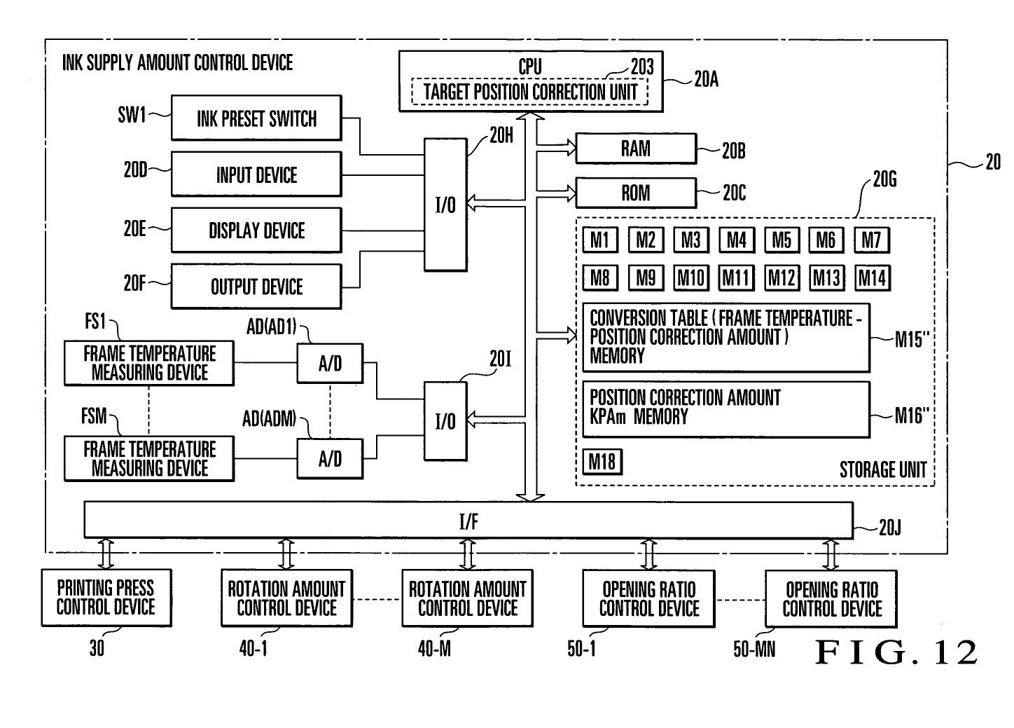

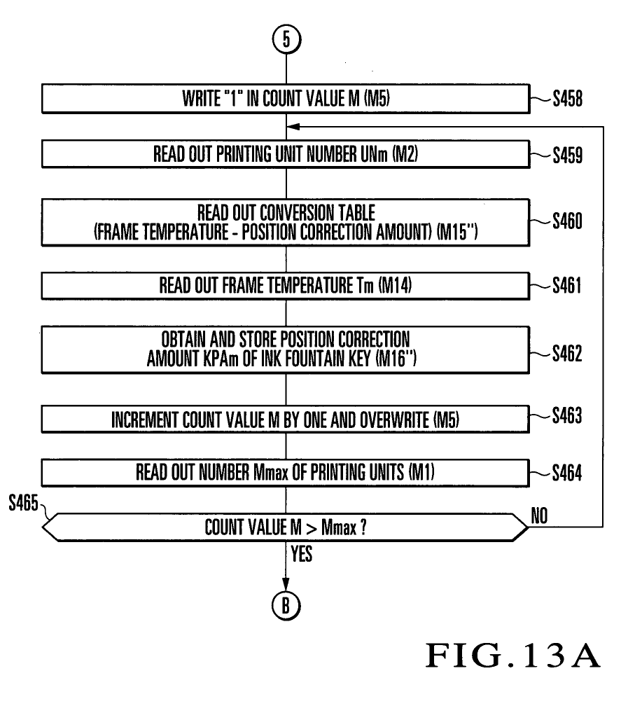

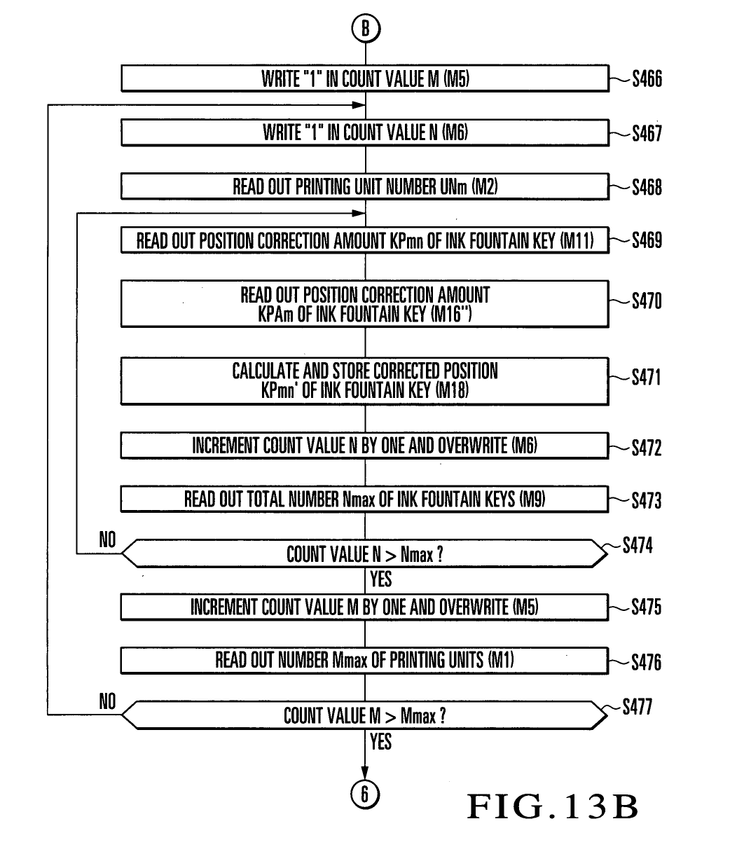

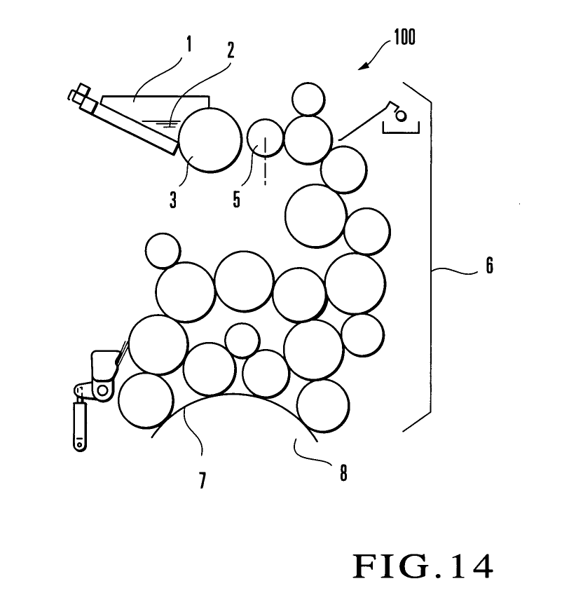

An ink supply amount control device for a printing press according to the third embodiment of the present invention will be described with reference to FIG. 12. The same reference numerals as in FIG. 3 denote the same or similar constituent elements in FIG. 12, and a description thereof will not be repeated. Rotation amount control devices 40-1 to 40-M and opening ratio control devices 50-1 to 50-MN connected to an ink supply amount control device 20 shown in FIG. 13 are also the same as in FIG. 3. A description of the detailed arrangements of these devices shown in FIGS. 4 and 5 and the flowcharts shown in FIGS. 8A, 8B, and 9 will not be repeated.

In the third embodiment, a storage unit 20G incorporates a memory M15″ to store the frame temperature—ink fountain key position correction amount conversion table of each printing unit, and a memory M16″ to store a position correction amount KPAm of an ink fountain key of a printing unit with a printing unit number UNm in place of the memories M15 and M16 of the first embodiment. A frame temperature—ink fountain key position correction amount conversion table representing the relationship between a frame temperature T of each printing unit and the position correction amount KPAm of an ink fountain key is set in the memory M15″. A CPU 20A has a target position correction unit 203 that corrects the target positions of ink fountain keys 4 in accordance with the outputs from frame temperature measuring devices FS1 to FSM.

FIGS. 13A and 13B illustrate a processing operation executed by the CPU 20A of the ink supply amount control device 20 according to the third embodiment. In these flowcharts, the processing operation up to step S458 (FIG. 13B) is the same as in steps S101 (FIG. 7A) to S157 (FIG. 7F) described in the first embodiment, and a description thereof will not be repeated. The processing operation from step S477 in FIG. 13B is the same as in steps S190 to S201 (FIG. 7J) described in the first embodiment, and a description thereof will not be repeated.

### [Calculation of Position Correction Amounts of Ink Fountain Keys]

If a count value M exceeds Mmax in step S157 (FIG. 7F), the CPU 20A sets the count value M in a memory M5 to “1” (FIG. 13A: step S458) and repeats the processing operation in steps S459 to S465. The position correction amounts KPAm of the ink fountain keys of the printing units to be used for printing are calculated by repeating the processing operation in steps S459 to S465.

The processing operation in steps S459 to S465 will be described. The CPU 20A reads out, from a memory M2, the printing unit number UNm of the Mth (M=1) printing unit to be used for printing (step S459). The frame temperature—ink fountain key position correction amount conversion table of the printing unit with the Mth (M=1) printing unit number UNm is read out from the memory M15″ (step S460). A frame temperature Tm of the printing unit with the Mth (M=1) printing unit number UNm is read out from a memory M14 (step S461).

The position correction amount KPAm of the ink fountain key of the printing unit with the Mth (M=1) printing unit number UNm is obtained by using the frame temperature—ink fountain key position correction amount conversion table of the printing unit read out in step S460 on the basis of the frame temperature Tm of the printing unit and stored in the memory M16″ (step S462).

The CPU 20A increments the count value M in the memory M5 by one to set M=2 (step S463) and reads out, from a memory M1, a number Mmax of printing units to be used for printing (step S464). The process in steps S459 to S465 is repeated until the count value M exceeds the number Mmax of printing units. With this process, the position correction amounts KPAm of the ink fountain keys of all printing units to be used for printing are obtained and stored in the memory M16″.

### [Correction of Target Positions of Ink Fountain Keys]

If the count value M exceeds Mmax in step S465, the CPU 20A sets the count value M in the memory M5 to “1” (FIG. 13B: step S466) and repeats the processing operation in steps S467 to S477. Corrected positions KPmn′ of the ink fountain keys of the printing units to be used for printing are obtained by repeating the processing operation in steps S467 to S477.

The processing operation in steps S467 to S477 will be described. The CPU 20A sets a count value N in a memory M6 to “1” (step S467) and reads out, from the memory M2, the printing unit number UNm of the Mth (M=1) printing unit to be used for printing (step S468). A target position KPmn of the Nth (N=1) ink fountain key of the printing unit with the Mth (M=1) printing unit number UNm is read out from a memory M11 (step S469). The position correction amount KPmn of the ink fountain key of the printing unit with the Mth (M=1) printing unit number UNm is read out from the memory M16″ (step S470).

The position correction amount KPAm of the ink fountain key of the printing unit with the Mth (M=1) printing unit number UNm is added to the target position KPmn of the Nth (N=1) ink fountain key of the printing unit with the Mth (M=1) printing unit number UNm read out in step S469. The sum is stored, in a memory M18, as the corrected position KPmn′ (KPmn′=KPmn+KPAm) of the Nth (N=1) ink fountain key of the printing unit with the Mth (M=1) printing unit number UNm (step S471).

The CPU 20A increments the count value N in the memory M6 by one to set N=2 (step S472) and reads out a total number Nmax of ink fountain keys of each printing unit from a memory M9 (step S473). The process in steps S467 to S474 is repeated until the count value N exceeds the total number Nmax of ink fountain keys. With this process, the corrected positions KPmn′ of the ink fountain keys of the printing unit with the Mth (M=1) printing unit number UNm are obtained and stored in the memory M18.

If the count value N exceeds Nmax (YES in step S474), the CPU 20A increments the count value M by one to set M=2 (step S475) and reads out, from the memory M1, the number Mmax of printing units to be used for printing (step S476). The process in steps S467 to S477 is repeated until the count value M exceeds the number Mmax of printing units. With this process, the corrected positions KPmn′ of the ink fountain keys of all printing units to be used for printing are obtained and stored in the memory M18. The target position correction unit 203 of the CPU 20A executes the above-described process in steps S458 to S477.

### [Transmission of Corrected Positions of Ink Fountain Keys]

If the count value M exceeds Mmax in step S477, the CPU 20A sets the count value M in the memory M5 to “1” (FIG. 7J: step S190) and repeats the processing operation in steps S191 to S201. The corrected positions KPmn′ of the ink fountain keys of the printing units to be used for printing are transmitted to the opening ratio control devices 50-1 to 50-MN of the printing units by repeating the processing operation.

In the above-described embodiments, the temperature of the ink fountain roller, the ink fountain key, or a printing press member near them may be the temperature of the ink fountain roller itself, the temperature of the ink fountain key itself, the temperature of the member itself close to the ink fountain roller, or the temperature of the member itself close to the ink fountain key. The temperature may be the temperature of a member located at the intermediate position between the ink fountain roller and the ink fountain key.

As described above, according to the present invention, the temperature of the ink fountain roller, ink fountain key, or a printing press member near them is measured, and the position of each ink fountain key is corrected in accordance with the measured temperature of the printing press member. Correcting the position of the ink fountain key itself, the home position of the ink fountain key, or the opening ratio of the ink fountain key allows to maintain a predetermined gap amount between the ink fountain key and the ink fountain roller and prevent any changes in color tones of printed products during printing even when the machine thermally expands due to a temperature change.

What is claimed is:

1. An ink fountain key position adjusting method for a printing press, comprising the steps of:
measuring a temperature of one of a plurality of members of an inking device including an ink fountain roller and a plurality of ink fountain keys; and
correcting a position of each ink fountain key with respect to the ink fountain roller in accordance with the measured member temperature.

2. A method according to claim 1, wherein the correcting step comprises the step of correcting a home position of the ink fountain key in accordance with the measured member temperature.

3. A method according to claim 1, wherein the correcting step comprises the step of correcting an opening ratio of the ink fountain key in accordance with the measured member temperature.

4. A method according to claim 1, wherein the correcting step comprises the step of correcting a target position of the ink fountain key in accordance with the measured member temperature.

5. A method according to claim 1, wherein the measuring step comprises the step of measuring a temperature of a printing press frame near the ink fountain roller.

6. A method according to claim 1, wherein the measuring step comprises the step of measuring a temperature of a printing press frame near the ink fountain key.

7. An ink fountain key position adjusting apparatus for a printing press, comprising:
temperature measuring means for measuring a temperature of a member of an ink fountain device including an ink fountain roller and ink fountain keys; and
correction means for correcting a position of each ink fountain key in accordance with the measured member temperature output from said temperature measuring means.

8. An apparatus according to claim 7, wherein said correction means comprises a home position correction unit which corrects a home position of the ink fountain key in accordance with the measured member temperature.

9. An apparatus according to claim 7, wherein said correction means comprises an opening ratio correction unit which corrects an opening ratio of the ink fountain key in accordance with the measured member temperature.

10. An apparatus according to claim 7, wherein said correction means comprises a target position correction unit which corrects a target position of the ink fountain key in accordance with the measured member temperature.

11. An apparatus according to claim 7, wherein said temperature measuring means measures a temperature of a printing press frame near the ink fountain roller.

12. An apparatus according to claim 7, wherein said temperature measuring means measures a temperature of a printing press frame near the ink fountain key.
